(19) United States
(12) Patent Application Publication
(10) Pub. No.: US 2005/0212165 A1
(43) Pub. Date: Sep. 29, 2005

(54) Method and apparatus for producing film

(75) Inventors: Hidekazu Yamazaki, Kanagawa (JP); Koju Ito, Kanagawa (JP); Misao Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/090,049

(22) Filed: Mar. 28, 2005

(30) Foreign Application Priority Data
Mar. 26, 2004 (JP) 2004-093275

(51) Int. Cl. B29C 39/14

(52) U.S. Cl. 264/146; 264/216; 425/224

(57) ABSTRACT

A casting die casts onto a belt a dope containing TAC for producing a film after the drying. Edge determining devices having edge correction paths are attached to both sides of a main body of the casting die. Part of the dope is fed as edge correction dopes in edge correction paths, and the remaining part of the dope is fed as a main dope in the manifold. A thickness of the main dopes is regulated so as to control the thickness of the film. In a casting film formed from the dope, both edge portions are thicker than a middle portion, and therefore the strength of the edge portions and the casting film increases. Thus when the casting film is peeled from the belt, the peeling defects are reduced. The edge portions are slit of to obtain a thin film.

### BACKGROUND OF THE INVENTION

1. Field of the Invention

The present invention relates to a method and an apparatus for producing a film, more especially to a method and an apparatus for producing a cellulose ester film.

2. Description Related to the Prior Art

As a film base of a protective film for a polarizing filter and a wide view film, a cellulose ester film is used, and needs for thinning the cellulose ester film becomes larger. Further, since the needs for several optical properties becomes larger, the cellulose ester film is stretched in a film production process to provide a predetermined optical property. In order to produce the cellulose ester film, a solution casting method is performed. In the solution casting method, as described Japan Institute of Invention and Innovation (JIII) JOURNAL of No. 2001-1745, a polymer solution (hereinafter dope) is cast from a casting die onto a support to form a casting film, and a hot-air drying or a cooling for gelation is made to provide the casting film for self-supporting properties. Then the casting film is peeled from the support, stretched, dried and so on. In the solution casting method, the produced film is more excellent in the optical properties than in a melt-extrusion method.

The film peeled from the support is a thin and tender film and transported to a tenter device, in which the casting film is transported with use of rollers while both edge portions are clipped. In this case, when it is designated to make the cellulose ester film thinner, it becomes harder to stably transport the thinner casting film. Further, when the thickness of the both edge portions of the casting film is too large, part of the casting film remains on the support after the peeling in the film production in high speed. Further, when the lip clearance of the casting die is adjusted so as to form a casting film in which only the both edge portions are thick, a time for producing the cellulose film becomes longer, which causes the increase of the cost.

### SUMMARY OF THE INVENTION

An object of the present invention is to provide a method and an apparatus for producing a thin film at high speed.

As a result of earnest research in order to achieve the object and the other object, the inventor found that the above problems are resolved in a method other than that of adjusting of a lip clearance, such that only the edge portions might be thickened. In the method found by the inventor, edge correction paths are provided for feeding edge correction dopes therein, and a flow rates of the edge correction dopes are controlled by a controlling device other than that for controlling the lip-clearance. Thus the edge correction dopes are supplied to both sides in a casting die so as to independently control the thickness of the both edge portions of the film.

In a film production method of the present invention, a primary film is formed and a both lateral portions of the primary film is slit off. Thus a slit film is obtained. The both lateral portions satisfies conditions
0.1 cm≦W≦10 cm
65 μm≦T1≦T1m≦T2
In these formulae, W is a width of each lateral portion; T1 is an averaged thickness (μm) of both of the lateral portions; T1m is a maximal thickness of both of the lateral portions; T2 is a larger value between 2.0×T0(μm) and 130 μm; T0 is an averaged thickness of said slit film.

In a preferable embodiment of the film production method of the present invention, flowing conditions are satisfied:
0 μm≦(T0m−T0)μm≦20 μm
T0v≦T0±2 μm
In these formulae, T0m is a maximal thickness of a lateral region of said slit film, said lateral region is positioned in the range of 1 mm to 20 mm from an lateral edge; T0v is a thickness (μm) at an arbitrary position in a central region except said lateral regions.

In another preferable embodiment, the primary film is cellulose ester film. Particularly preferably, in order to form the primary film, a main dope is fed in a main path of a casting die, and correction dopes are fed in respective correction paths of the casting die. The correction paths are disposed in both sides of the main path. Then the correction paths are joined to the main dope at both edges of the main dope. Thus the casting dope is obtained. Thereafter, the casting dope is cast from the casting die onto a support so as to form the primary film.

Further, particularly preferably, in order to form the primary film, a flow rate of each of the correction dopes flowing through the correction paths is adjusted depending on thickness values of the lateral portions. When the correction dopes flow in the correction paths, airs generated from the correction dope is exhausted from the correction paths. Further, the temperature of the correction dope in each of the correction path is controlled to a predetermined value. Furthermore, the correction dopes are joined to the main dope in a downstream side from a position at which a width of the main dope becomes a casting width. A width of the primary film is at least 1400 mm.

In another embodiment of the film production method of the present invention, a main dope is fed in a main path of a casting die, and correction dopes are fed in respective correction paths of the casting die. The correction paths are disposed in both sides of the main path. Then a flow rate of each of the correction dopes flowing through the correction paths is adjusted depending on thickness values of lateral portions of a film. The correction paths are joined to the main dope at both edges of the main path. Thus the casting dope is obtained. Thereafter, the casting dope is cast from the casting die onto a support so as to form the film.

In another preferable embodiment, the film is cellulose ester film. When the correction dopes flow in the correction paths, airs generated from the correction dope is exhausted from the correction paths. A temperature of the correction dope in each of the correction path is controlled to a predetermined value. The correction dopes are joined to the main dope in a downstream side from a position at which a width of the main dope becomes a casting width. A width of the film is at least 1400 mm.

In a film production apparatus of the present invention that includes a casting die for casting a dope onto a support so as to form a film, the casting die includes a main path for feeding a main dope, a correction paths for respectively feeding correction dopes. The correction paths are disposed in both sides of the main path. The casting die further includes a flow rate adjusting device and a joining section. The flow rate adjusting device adjusts a flow rate of each of the correction dopes flowing through each of the correction paths depending on thickness values of lateral portions of a film. In the joining section, the correction dopes are joined to the main dope at both edges of the main path. Thus the casting dope is obtained.

In a preferable embodiment of the film production method, the casting die further includes a main body and an edge adjusting part attached to both sides of the main body. The main body is provided with the main path and the joining section. The edge adjusting part is provided with the correction path and a flow rate adjusting device.

A preferable embodiment of the film production apparatus furthermore includes through holes through which air generated from the correction dopes are exhausted while the correction dopes flow in the correction paths.

Still another preferable embodiment of the film production apparatus includes a temperature controller for controlling a temperature of the correction dope in each of the correction path to a predetermined value. Preferably, the joining section is disposed in a downstream side from a position at which a width of the main path becomes a casting width of the casting dope.

According to the method of producing the film of the present invention, a untrimmed film is formed and both edge portions thereof is slit off or trimmed off to obtain the produced film. A width W of each edge portion satisfies a condition of 0.1 cm≦W≦10 cm. If the averaged thickness of the untrimmed film is T0, the averaged thickness T1 of the both edge portions of the film satisfies a condition having a relation of a largest thickness T1m of the both edge portions and a larger value between 2.0×T0(μm) and 130 μm: 65 μm≦T1≦T1m≦T2. Thus, the edge portions of the a casting film formed on a support by casting a dope on the support becomes thicker and therefore whole of the untrimmed film becomes stronger. When the casting film is peeled from the support, the peeling failures are prevented, for example, that part of the casting film remains on the support. In the method in which only the both edge portions are thicken, the casting die is provided with edge correction paths for feeding edge correction dopes, which are joined in side portion of the main dope in the main path so as to thicken the edge portions of the untrimmed film. Thus the preset invention can be performed by a small improvement of the prior equipment, and the cost becomes lower. Further, the flow rates of the edge correction dopes is controlled without controlling the lip clearance. Therefore the control of the film thickness is made at high accuracy. Furthermore, the produced film is thin and has good surface conditions. A protective film for a polarizing filter, an optical functional film, a polarizing filter, a liquid crystal device and the like, in which the produced thin film is used, are excellent in the optical properties.

The apparatus for producing the film of the present invention, in which the casting die has a main body and the edge correction paths for feeding the edge correction dope therein. Thus the thickness of the both edge portions can be independently controlled. Therefore, the untrimmed film in which the both edge portions has different thickness than the middle portion can be easily formed.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a film production line used for a method of producing the film in the present invention;

FIG. 2 is a sectional view of a die used in a film production apparatus of the present invention;

FIG. 3 is a sectional view of a untrimmed film before the slitting of both edge portions.

### PREFERRED EMBODIMENTS OF THE INVENTION

[Solvent]

Well-known compounds can be used as a solvent for preparing a dope in the present invention. Preferably, there are hydrocarbon halides (methylene chloride (dichloromethane) and the like), esters (methylacetate and the like), ethers, alcohols (methanol, ethanol, n-butanol and the like), ketones (acetone and the like), and the like. However, the compounds for the solvent are not restricted in them. Further, in the present invention, a mixture solvent as a mixture of the several sorts of the above solvents may be used for preparing the dope from which the film can be produced. In the present invention, the mixture solvent in which the dichloromethane is a main solvent is called a dichloromethane type solvent, and the mixture solvent in which the methylacetate is a main solvent is called a methylacetate type solvent.

[Polymer]

The polymers used in the present invention is not restricted especially. For example, there are cellulose esters, (such as cellulose acylate), polyethylene telephthalate, polybutylene telephthalate, polyethylene-2,6-naphthalate and the like. However the polymer is not restricted in them. Further, it is preferable to use a cellulose acylate, especially a cellulose triacetate (TAC) whose acetylation degree is from 59.0% to 62.5%. Further, the raw materials of the TAC is a cotton linter and a wood pulp. When the TAC is used, one or a mixture of the TAC from the cotton linter and that from the wood pulp may be used.

[Additive]

Several sorts of already known compounds can be added as additives to the dope. As the additives, there are plasticizers (triphenylphosphate (or TPP); biphenyldiphenyl phosphate (BDP) and the like), ultraviolet absorbing agents (2,4-bis-(n-octylthio)-6-(4-hydroxy-3,5-di-tert-butylanylino)-1,3,5-triazine; 2-(2′-hydroxy-3′,5′-di-tert-butylphenyl)-5-chlorobenzotriazol; and the like), matting agents (silicon dioxide and the like), thickners, oil-gelation agents and the like. however, the additives are not restricted in them. The additives may be added with the polymer to the solvent for preparing the dope. Otherwise, in the feeding of the prepared dope, the additives may be added to the dope to make an inline mixing with use of a static mixer and the like.

[Preparation of Dope]

After the polymer is added into the solvent (which may be the mixture solvent), the polymer is dissolved by a dissolving method already known, so as to prepare the dope. At the same time, the dissolution of the additives may be performed. Usually, the filtration of the dope is made so as to remove foreign materials. In the filtration, filtration materials already known can be used, such as a filtration paper, a filtration cloth, nonwoven cloth, metal mesh, sintered metal, multi-pore filter, and the like. When the filtration is made, the foreign materials and undissolved particles in the dope can be removed, and thus the defects caused by the foreign materials in the produced film are reduced. Note that, it is preferable to use one of the dichloromethane type solvent or the methylacetate type solvent.

Further, the prepared dope may be heated so as to increase a solubility. In order to heat the dope, there are, for example, a method of heating with stirring in a stationary-disposed tank, a method of heating with transporting the dope with use of several sorts of heat exchangers, such as a jacket tube with static mixer and the like. Further, the inner pressure in the device may be increased so as to heat the dope to more than the boiling point under the atmospheric pressure. When such processing is made, the undissolved particles are completely dissolved, or the load of the filtration is decreased. Further, the number of the foreign materials can be decreased.

[Film Production Method]

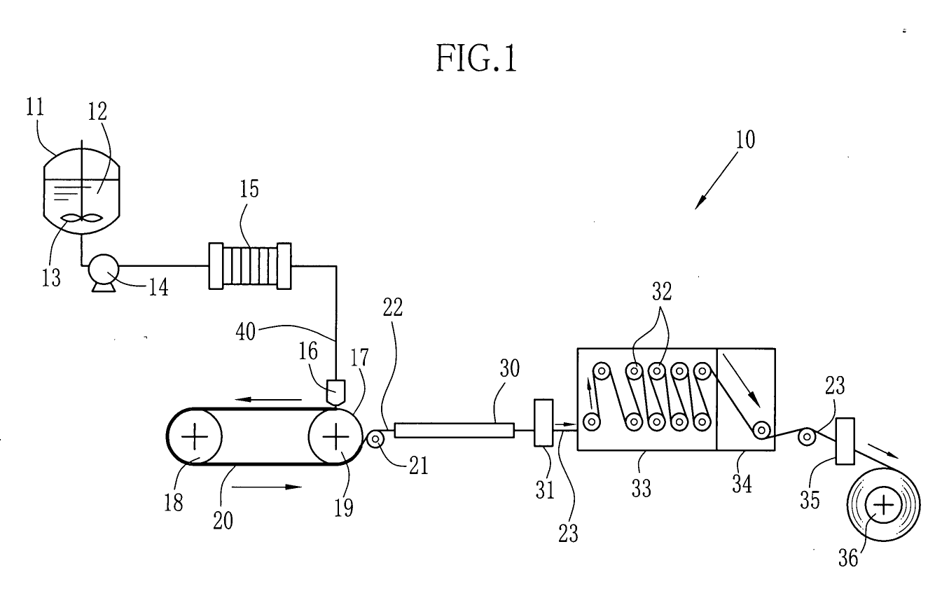

In FIG. 1, in a mixing tank 11 of a film production line 10, the dope prepared in the above method is supplied as a dope 12 and stirred by rotating stir blades 13 to be uniform. The dope 12 is fed to a filtration apparatus 15 by a pump 14 so as to remove impurities, and further fed to a casting die 16 at a constant flow rate. The casting die 16 is disposed on a belt 17, which is circulatory and endlessly moves in accordance with rotation of rollers 18,19 by a rotating device (not shown). The casting die 16 cast the dope 12 onto the belt 17. Note that a casting method will be explained later in detail. The dope 12 forms a casting film 20 on the belt 17 to have a self-supporting property, and thereafter peeled as an untrimmed film 22 by a peel roller 21. In this embodiment, the belt is used as the support. However, the present invention is not restricted in it, and the support may be a drum.

The untrimmed film 22 is dried in a tenter dryer 30. In the course of the drying, the untrimmed film 22 is stretched in at least one of a widthwise direction and a lengthwise direction so as to obtain the predetermined film. Thus the necessary optical properties are provided with the untrimmed film 22, and it is prevented that the wrinkles occur on a film surface.

Before the stretching, two points arranged in a stretching direction are determined on the untrimmed film 22, and a distance between them is measured as a first distance X. Then after the stretching, a distance between the two points are measured as a second distance Y. Thus a stretch ratio Rₛₜᵣ is defined as:
Rₛₜᵣ=[(Y−X)/X]×100
The stretch ratio is not restricted especially, but the untrimmed film 22 is preferably stretched at the stretch ratio in the range of 0.5% to 150%. Thereafter, both edge portions of the untrimmed film 22 are slit off or trimmed off by a slitting device 31, and thus a trimmed film 23 having a predetermined width is obtained as a produced film. The trimmed film 23 is transported to a drying chamber 33 in which there are many rollers 32, and cooled in a cooling chamber 34 after the drying in the drying chamber 33. Although a cooling temperature is not restricted especially, the trimmed film 23 is cooled, for example, to a room temperature. Further, both edge portions of the trimmed film 23 are slit off by a slitting device 35. The cooled trimmed film 23 is wound by a winding apparatus 36, and meanwhile the adhesion of the trimmed film 23 in a film roll is prevented. In the present invention, the number of the slitting devices is not restricted in two. For example, the slitting device may be provided just in a downstream side from the tenter dryer 30 (at a position of the slitting device 31) or just before the winding (at a position of the slitting device 35). Furthermore, the slitting devices may be provided in the drying chamber 33 or the cooling chamber 34.

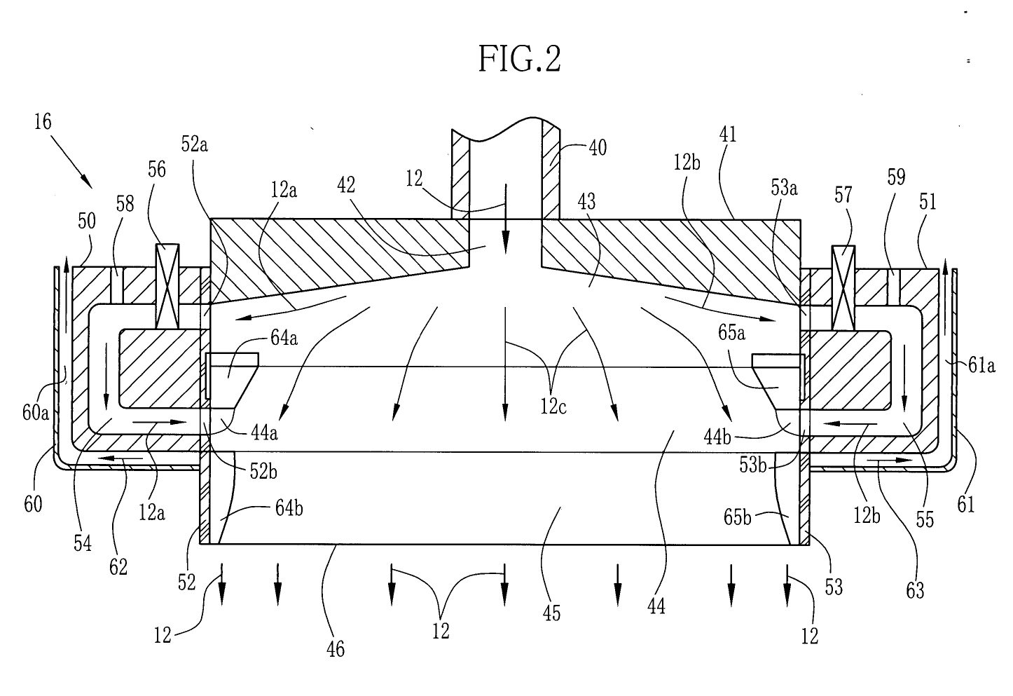

A casting method and a casting devices in the method of producing the film of the present invention will be described in detail in reference with FIG. 2. The casting die 16 includes a main body 41 and edge determining devices 50, 51. Further, the main body 41 has a structure so as to make the width of the dope 12 for the casting larger. The dope 12 is fed in the pipe 40 and supplied through a main path 42 into the widening area 43 of the casting die 16. Then the dope enters into a manifold 44 whose width is the same as that of a lower end of the widening area 43. Then the dope is supplied to a slit 45 in which the thickness of the dope is regulated to a predetermined value, and discharged from an aperture 46.

In the edge determining devices 50,51, edge correction paths 54,55 are respectively formed. Further, a packing 52 has an opening 52a as an entrance of the edge correction path 54 and an opening 52b as an exit of the edge correction path 54, and a packing 53 has an opening 53a as an entrance of the edge correction path 55 and an opening 53b as an exit of the edge correction path 55. Preferably, the openings 52a, 53a are positioned after the width of the dope 12 becomes enough large in the widening area 43. If the dope 12 is fed into the edge correction paths 54,55 before the complete of the widening, the flow of the dope in the main body 41 is sometimes turbulent. Preferably, the openings 52b, 53b are positioned after the widening of the dope 12 becomes completed. Therefore the openings 52b,53b are preferably formed on the manifold 44. The dope in the main body 41 is fed from the main path 42 to the manifold 44 while the dope 12 becomes wider. In the manifold 44, conditioning guides 64a,65a are provided in both sides so as to make the flow of the dope 12 in the edge correction paths 54,55 smooth. In downstream sides from the guides 64a,65a, there are guides 64b,65b for making the thickness of the dope 12 uniform. Usually, when the dope 12 is cast, both edge portions of the casting film become thicker in effect of a surface tension of the dope 12. However, this phenomena is hardly controlled even if the lip clearance of the casting die 16 is adjusted. Therefore, usually, the guides 64b,65b are provided and then the casting of the dope 12 is made such that the both edge portions of the casting film 20 may not become thicker.

In the edge correction paths 54,55, there are flow rate regulators 56,57, in which the flow rates of the dope 12 are regulated by throttle valves (not shown) so as to control the thickness of the edge portions of the casting film 20. Therefore the thickness of edge portions of the produced film can be controlled. Further, the edge correction paths are preferably connected to air exhausting holes 58,59 for removing the air from the edge correction paths 54,55 to an outside. In this case, the generation of pores or voids in the casting film 20 is prevented.

The dopes flowing in the edge correction paths 54,55 are edge correction dopes 12a,12b, and the dope flowing through the manifold 44 to the slit 45 is a main dope 12c. The edge correction dopes 12a,12b and the main dope 12c are joined. In this case, when these dopes 12a-12c have different temperatures from each other at the joining, an interface between the edge correction dopes 12a,12b after the joining sometimes occurs, and thus, condition of the film surface in the widthwise direction of the film often becomes worse. Therefore, in order to regulate the temperatures of the edge correction dopes 12a,12b, a device or a member for controlling temperature is preferably provided. In FIG. 2, jackets 60,61 are provided, and heat transfer mediums (fluids) 62,63 are respectively fed into passages 60a,61a so as to control the temperature of the edge correction dopes 12a,12b. However, in the present invention, the device or a member for controlling temperature is not restricted especially, and may be a heater and the like. Further, the heat transfer medium is not restricted especially. However, it is preferably water, brine (trade name), oil and the like.

The guides 64a,65a are disposed such that the width of the main dope 12c becomes larger. Thus the edge correction dopes 12a,12b can be fed to both edges of the main dope 12c. Further, at the positions at which the edge correction dopes 12a, 12b are fed back into the manifold 44, basins 44a,44b are provided for thickening the edge correction dopes 12a,12b. Thus the thickness of the edge correction dopes 12a,12b is corrected. Note that the basins 44a,44b are, for example, formed in the manifold 44.

In the casting, the dope 12 is fed from the pipe 40 through the main path 42 to the widening area 43, in which the width of the dope 12 becomes larger to that of the manifold 44. Part of the dope 12 enters as the edge correction dopes 12a,12b into the edge correction paths in the edge determining devices 50,51. Further, another part of the dope 12 flows as the main dope 12c toward the manifold 44, whose width is regulated by the guides 64a,65a. The edge correction dopes 12a,12b flowing in the edge correction paths 54,55 enters into the basins 44a,44b of the manifold 44. Thus after the joining of the edge and main dopes 12a-12c, the edge portions is thicker than a middle portion in the edge correction dopes 12a,12b. Then the dope 12 is fed through the slit 45 and cast from the aperture 46 onto the belt 17 (see, FIG. 1). Since the edge portions is thicker than a middle portion in the dope 12, the both edge portions of the casting film 20 becomes thicker.

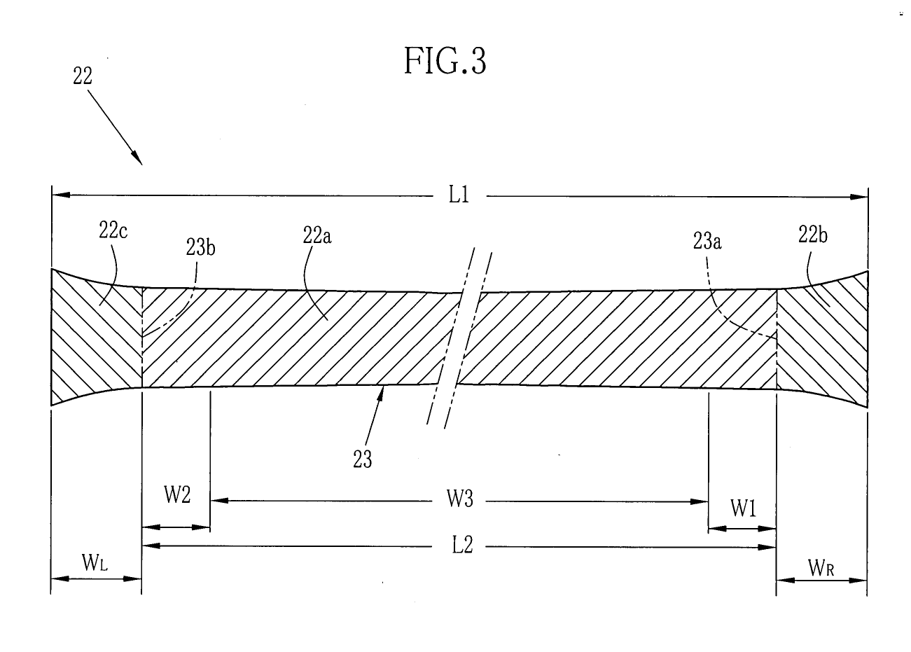

The thickness distribution of the casting film 20 (namely of the untrimmed film 22) in the widthwise direction is controlled by regulating the discharging distribution of the dope 12 in a widthwise direction through an aperture 46 formed between lips of the casting die 16. The thickness of the production portion 22a (see, FIG. 3) of the untrimmed film 22, namely a trimmed film (see, FIG. 3), can be regulated by varying a lip clearance (or a distance between the lips). Otherwise, since the casting die 16 is provided with the guides 64b,65b for determining a width of the casting, it is hard to regulate the discharging distribution by varying the lip clearance. Further, adequate forms of the guides 64b,65b in the manifold 44 must be changed in accordance with the variation of the film thickness. Therefore, when the thickness of the produced film is varied, the guides 64b,65b are exchanged in order to provide the predetermined distribution of the film thickness. In this case, the drive of the film production line is stopped, and after the exchange of the guides, it is necessary to make the trial production of the film for a fine adjustment of the thickness distribution in the widthwise direction of the film. Thus, the exchange of the guide in the manifold is not practical.

However, in this embodiment, edge determining devices 50,51 are attached to the main body 41. Further, if P0(Pa) is a pressure loss of the main dope 12c from the main path 42 to the aperture 46 and P1(Pa) is a pressure loss of the edge correction dopes 12a,12b at the same flow speed (m/d) from the main path 42 to the aperture 46, the pressure losses P0,P1 satisfies a following condition:
P0>P1+1000 Pa
The pressure loss P1 is easily controlled by adjusting a gate opening. Therefore, the both edge portions of the casting film 20 can be regulated, so as to easily control the thickness distribution of the film in the widthwise direction.

Since both edge portions of the casting film 20 is large, the strength of the casting film 20 becomes enough, and therefore even if the thickness of the produces film is thin, the edge portions of the untrimmed film 22 has a enough strength not so as to be broken by supporting with clips or pins in the tenter dryer 30.

As shown in FIG. 3, edge portions 22b,22c of the untrimmed film 22 have widths W_{R},W_{L} in the widthwise direction of the untrimmed film 22, and the widths W_{R},W_{L} is from 0.1 cm to 10 cm. If the widths W_{R},W_{L} are less than 0.1 cm, it becomes hard to keep a supporting strength in the tenter dryer 30, and therefore the enough effect of the preset invention cannot be obtained. Further, if the widths W_{R},W_{L} are more than 10 cm, the width of the untrimmed film 22 becomes larger, and the edge portions to be slit off from the untrimmed film becomes wider. When thick part becomes larger in the dope to be cast, the feed pressure of the dope becomes too high at the aperture. In this case, it is sometimes hard to continuously cast from the casting die the dope whose content is uniform.

If T1 is an averaged thickness of the edge portions 22b, 22c, Tim is the maximal thickness of the edge portions 22b,22c, and T0 is the averaged thickness of the production portion, the averaged thickness T1 of the edge portions 22b,22c satisfies a formula:
65 μm≦T1≦T1m≦T2 (1)
(T2 is a largest value between 130 μm and 2.0×T0)
   In the present invention, the averaged thickness T1 of the edge portions 22b, 22c and the averaged thickness T0 of the production portion are measured with use of a thickness gauge of a non-contact type.

The method of the present invention is performed to produce a thin film (whose thickness is in the range of 20 μm to 85 μm, for example). The thickness T1 of the edge portions 22b,22c is in the range of 65 μm to 170 μm. Further, the thickness of the edge portions 22b,22c may be constant (namely, T1=Tm1). However, the shape of the casting die and the method of feeding the dope are usual as far as possible, such that the cost of improving the equipment may be low. Therefore in the present invention, it is enough to satisfy a condition, T1≦T1m.

However, if the upper limit of the maximal value T1m of the edge portions 22b,22c is much larger than the averaged thickness T0 of the production portion 22a, the edge and main dopes 12a-12c cannot join adequately, and the interface between the edge and main dopes 12a-12c often occur. Thus the dope 12 cast from the casting die is not continuous in the widthwise direction. Therefore, the upper limit of the maximal value T1m of the edge portions 22a,22b is a larger value between 130 μm and 2.0×T0 such that the casting failure may be reduced.

The width L1 of the untrimmed film 22 is preferably at least 2000 mm, and particularly at least 1400 mm. After the both edge portions 22b,22c of the untrimmed film 22 are slit off, the production portion 22a becomes the trimmed film 23, whose width L2 is preferably at least 1200 mm, and particularly 1400 mm. Further, if the maximal thickness of side areas W1,W2 of the production portion 22a between edges 23a,23b of the production portion 22a is T0m(μm), a following condition is preferably satisfied,
0 μm≦(T0m−T0)μm≦20 μm
The side areas W1,W2 are from 1 mm to 20 mm in the widthwise direction of the untrimmed film 22, and adequately determined depending on the width L2 of the trimmed film 23. Further, the trimmed film 23 is preferably formed such that a thickness distribution of a central area W3 may be T0(μm)±2 μm. In this case, the trimmed film 23 may be preferably used as a base film of the protective film for the polarizing filter and a wide view film.

Note that the method and the apparatus for producing the film of the present invention are not restricted in the above description. To the method of the preset invention may be applied a co-casting method in which a feed block and a multi-manifold die are used or a sequentially casting method in which plural casting dies are arranged above the support.

The trimmed film 23 obtained by the film production method of the present invention can be used as the protective film for the polarization filter, in which the protective films are adhered to both surfaces of a polarized film formed of polyvinyl alcohol. Further, the film may be used for the optically functional films, such as an optical compensation film in which the trimmed film 23 is adhered to an optical compensation sheet, an antireflective film in which an antiglare layer is formed on the trimmed film 23, a wide view film and the like. These products can be used for constructing a liquid crystal display in a liquid crystal displaying device.

### EXAMPLE

In following, an example of the present invention is explained in detail. The embodiment of the present invention is not restricted in the example. In example, Experiments 1-3 and Experiment 4 as Comparison were made. The explanation of Experiment 1 is made in detail, and that of Experiments 2-4 follows, in which the same explanations will be omitted.

In Experiment 1, a dope A is used. In the dope A, the solvent was a dichloromethane type mixture solvent containing dichloromethane (64 pst.wt.), methanol (16 pts.wt.) and n-butanol (0.4 pts.wt.). As the polymer, cellulose acetate (20 pts.wt.) synthesized from the wood pulp was used, and an acetylation degree of the cellulose acetate was 62%. The additives were used, which were the plasticizer (TPP:BDP=2:1, 2.2 pts.wt. in total), the UV absorbing agent and the matting agent (total content of the UV-absorbing agent and the matting agent was 0.02 pts.wt). Note that the dope was prepared by an already known method in which the dichloromethane was the main solvent.

The film was produced with use of the film production line in FIG. 1. The casting die was the single layer type casting die. To both sides of the casting die 16 were attached edge determining devices 50,51. The flow rate of the edge correction dopes were regulated such that the thickness of the edge portion of the film might be 20 μm larger. The heat transfer mediums 62,63 at 34.5° C. were fed in the jackets 60,61, such that the edge correction paths 54,55 might be 34° C. A cross-sectional area of each edge correction path 54,55 was 12 cm², and a cross-sectional area of each air exhausting hole 58,59 was 0.8 cm². The temperature of the belt 17 was controlled to 25° C. The rotation of the rollers 18,19 was controlled such that the casting speed might be 60 m/min. The dope at 34° C. was cast onto the belt 17. When the casting film 20 had the self-supporting property, the untrimmed film was peeled from the belt 17 with support of the peel roller 21, and then dried at 130° C. for three minutes in the tenter dryer in which the tenter clips were pins. Further, the untrimmed film was stretched to be larger by 1% in the situation that the content of the remaining solvent is 30 wt. % to the content of solid materials. Thereafter, the untrimmed film was dried at 135° C. in the drying chamber 33 for 10 minutes, and then transported with the cooling at 80° C. in the cooling chamber 34 for 3 minutes. Thus the film was wound up by the winding apparatus 36.

The averaged thickness T0 of the untrimmed film was 60 μm and the averaged thickness T1 of both edge portions was 102 μm. The formula (1) was satisfied:
65 μm≦T1(102 μm)≦130 μm(2.0×T0(60 μm)<130 μm)
Further, the stability of transporting the untrimmed film 22 in the tenter dryer 30 was excellent.

In Experiment 2, the averaged thickness T0 of the untrimmed film was 30 μm and the averaged thickness T1 of both edge portions was 98 μm. the conditions were changed such that the edge correction dopes might form part of the edge portions to have the thickness 41 μm in average in each 98 μm edge portion. Other conditions were the same as in Examination 1. The formula (1) was satisfied:
65 μm≦T1(98 μm)≦130 μm(2.0×T0(30 μm)<130 μm)
Further, the stability of transporting the untrimmed film 22 in the tenter dryer 30 was excellent.

In Experiment 3, the averaged thickness T0 of the untrimmed film was 30 μm and the averaged thickness T1 of both edge portions was 73 μm. the conditions were changed such that the edge correction dopes might form part of the edge portions to have the thickness 16 μm in average in each 73 μm edge portion. Other conditions were the same as in Examination 1. The formula (1) was satisfied:
65 μm≦T1(73 μm)≦130 μm(2.0×T0(30 μm)<130 μm)
After the untrimmed film 22 was transported in the tenter dryer 30, the edge portions were slightly ruptured from the hole formed by the pins. However, there were no problem for use.

In Experiment 4 as the comparison, the averaged thickness T0 of the untrimmed film was 30 μm and the averaged thickness T1 of both edge portions was 57 μm. The conditions were changed such that the edge correction dopes might form part of the edge portions to have the thickness 0 μm in average in each 57 μm edge portion. Other conditions were the same as in Examination 1. In this case, the averaged thickness T1 had a relation of:
65 μm>T1(57 μm)
Therefore the formula (1) was not satisfied. In the tenter dryer 30, the edge portions were ruptured at some positions, and the film couldn't be continuously formed.

A feed block was provided in upstream side from the single layer casting die, and the multi-layer casting was made in the same conditions in Examinations 1-4. The effects in these castings were the same as in the single layer casting.

Various changes and modifications are possible in the present invention and may be understood to be within the present invention.

1. A film production method comprising steps of:
(A) forming a primary film;
(B) slitting off both lateral portions of said primary film so as to obtain a slit film, both of said lateral portions satisfying following conditions:
0.1 cm≦W≦10 cm
65 μm≦T1≦T1m≦T2
wherein W is a width (cm) of each of said lateral portion; T1 is an averaged thickness (μm) of both of said lateral portions; T1m is a maximal thickness (μm) of both of said lateral portions; T2 is a larger value between 20.0×T0(μm) and 130 μm; T0 is an averaged thickness of said slit film.

2. A film production method as described in claim 1, further satisfying following conditions:
0 μm≦(T0m−T0)μm≦20 μm
T0v≦T0±2 μm
wherein T0m is a maximal thickness (μm) of both lateral regions of said slit film, each of said lateral region is positioned in the range of 1 mm to 20 mm from an lateral edge; T0v is a thickness (μm) at an arbitrary position in a central region except both of said lateral regions of said slit film.

3. A film production method as described in claim 2, wherein said primary film is cellulose ester film.

4. A film production method as described in claim 3, wherein the step (A) further comprises steps of:
(A1) feeding a main dope in a main path of a casting die;
(A2) feeding correction dopes in respective correction paths of said casting die; said correction paths being disposed in both sides of said main path;
(A3) joining said correction dopes to said main dope at both side edges of said main path, so as to obtain a casting dope; and
(A4) casting said casting dope from said casting die onto a support, so as to form said primary film.

5. A film production method as described in claim 4, wherein the step (A) further comprises:
(A5) adjusting a flow rate of each of said correction dopes flowing through said correction paths depending on thickness values of said lateral portions.

6. A film production method as described in claim 5, wherein when said correction dopes flow in said correction paths, airs generated from said correction dopes are exhausted from said correction paths.

7. A film production method described in claim 5, wherein a temperature of said correction dope in each of said correction path is controlled to a predetermined value.

8. A film production method as described in claim 5, wherein said correction dopes are joined to said main dope in a downstream side from a position at which a width of said main dope becomes a casting width of said casting dope.

9. A film production method as described in claim 5, wherein a width of said primary film is at least 1400 mm.

10. A film production method comprising steps of:
feeding a main dope in a main path of a casting die;
feeding correction dopes in respective correction paths of said casting die, said correction paths being disposed in both sides of said main path;
adjusting a flow rate of each of said correction dopes flowing through said correction paths depending on thickness values of lateral portions of a film;
joining said correction dopes to said main dope at both side edges of said main path, so as to obtain a casting dope; and
casting said casting dope from said casting die onto a support, so as to form said film.

11. A film production method as described in claim 10, wherein said film is cellulose ester film.

12. A film production method as described in claim 10, wherein when said correction dopes flow in said correction paths, airs generated from said correction dopes are exhausted from said correction paths.

13. A film production method described in claim 10, wherein a temperature of said correction dope in each of said correction path is controlled to a predetermined value.

14. A film production method as described in claim 10, wherein said correction dopes are joined to said main dope in a downstream side from a position at which a width of said main dope becomes a casting width of said casting dope.

15. A film production method as described in claim 10, wherein a width of said film is at least 1400 mm.

16. A film production apparatus including a casting die for casting a casting dope onto a support so as to form a film, said casting die comprising:
a main path for feeding a main dope;
correction paths for respectively feeding correction dopes, said correction paths being disposed in both sides of said main path;
a flow rate adjusting device for adjusting a flow rate of said correction dope flowing through each of said correction path depending on a thickness value of a lateral portion of a film;
a joining section for joining said correction dopes to said main dope at both side edges of said main path, so as to obtain a casting dope.

17. A film production apparatus as described in claim 16, wherein said casting die further comprises a main body and an edge adjusting part attached to both sides of said main body, said main body is provided with said main path and said joining section, and said edge adjusting part is provided with said correction paths and said flow rate adjusting device.

18. A film production apparatus as described in claim 16, further comprising exhausting holes for exhausting from said edge correction paths airs generated from said correction dope, while said correction dopes flow in said correction paths.

19. A film production apparatus as described in claim 16, further comprising a temperature controller for controlling a temperature of said correction dope in each of said correction paths to a predetermined value.

20. A film production apparatus as described in claim 16, wherein said joining section is disposed in a downstream side from a position at which a width of said main path becomes a casting width of said casting dope.
